(19) United States
(12) Patent Application Publication
(10) Pub. No.: US 2025/0066197 A1
(43) Pub. Date: Feb. 27, 2025

(54) BORON NITRIDE PARTICLES AND HEAT DISSIPATION SHEET

(71) Applicant: Denka Company Limited, Tokyo (JP)

(72) Inventors: Yusuke SASAKI, Saitama Saitama (JP); Kenji MIYATA, Machida Tokyo (JP); Michiharu NAKASHIMA, Machida Tokyo (JP)

(21) Appl. No.: 18/723,859

(22) PCT Filed: Dec. 23, 2022
(86) PCT No.: PCT/JP2022/047691

§ 371 Date: Jun. 24, 2024

(30) Foreign Application Priority Data
Dec. 27, 2021 (JP) 2021-213164

(51) Int. Cl. C01B 21/064; C08K 3/38

(52) U.S. Cl. CPC C01B 21/064; C08K 3/38; C01P 2002/82; C01P 2004/03; C01P 2004/61; C08K 2003/385; C08K 2201/001

(57) ABSTRACT

The boron nitride particle of the present invention in cross section includes a streaky void. The heat dissipation sheet of the present invention is obtained by forming a thermally conductive resin composition including the boron nitride particle of the present invention and a resin. According to the present invention, a boron nitride particle having a small porosity and a heat dissipation sheet including the boron nitride particle can be provided.

### TECHNICAL FIELD

The present invention relates to a boron nitride particle and a heat dissipation sheet including the boron nitride particle.

### BACKGROUND ART

Hexagonal boron nitride (hereinafter, referred to as “boron nitride”) has lubricity, high thermal conductivity, insulating properties, and the like, and is widely used as a solid lubricant, molten gas, a release agent for aluminum or the like, a filler for a heat dissipation material, and the like.

In particular, in recent years, the importance of heat dissipation measures has increased due to higher performance of computers and electronic devices, and the high thermal conductivity of boron nitride has attracted attention. In addition, the addition of boron nitride has been studied for the purpose of imparting further higher thermal conductivity and insulating properties to a heat dissipation sheet.

Boron nitride has a scale shape, and thermal properties thereof are overwhelmingly superior in a major axis or minor axis direction as compared with a thickness direction. Further, when boron nitride is used as the thermally conductive filler of the heat dissipation sheet, in many cases, the boron nitride lies in a lateral direction, and does not exhibit sufficient thermal characteristics required in a longitudinal direction. Therefore, in order for boron nitride to be suitable as a thermally conductive filler, it is necessary to reduce the influence of the directionality due to the scale shape of boron nitride by forming boron nitride into a spherical shape or an aggregated shape.

Boron nitride is generally obtained by reacting a boron source (boric acid, borax, and the like) with a nitrogen source (urea, melamine, ammonia, and the like) at a high temperature, and boron nitride in the form of “pine cone” in which scale-shaped primary particles are aggregated from boric acid and melamine has been proposed (PTL 1). This makes it possible to reduce the influence of directionality due to the scale shape of boron nitride. The average particle diameter of the aggregated particles of boron nitride produced by this method is usually 50 μm or more.

Further, it has been proposed to produce spherical boron nitride fine particles by reacting a boric acid alkoxide with ammonia in an inert gas stream, heat-treating it in an atmosphere of ammonia gas or a mixed gas of ammonia gas and an inert gas, and then further firing it in an inert gas atmosphere (PTL 2). This eliminates the directionality of the boron nitride. The boron nitride produced by this method has an average particle diameter of 0.01 to 1.0 μm.

In addition, a combination of boron nitride powders having different average particle diameters and aggregated shapes has been studied. For example, it has been proposed to use, as a thermally conductive filler, a mixed boron nitride powder obtained by mixing a boron nitride powder formed by aggregation of primary particles of boron nitride and having an average particle diameter of 5 μm or more and less than 30 μm and a boron nitride powder formed by aggregation of primary particles of boron nitride and having an average particle diameter of 50 μm or more and less than 100 μm (PTL 3). By this, the voltage resistance of the heat dissipation sheet can be improved.

### CITATION LIST

### Patent Literature

PTL 1: JPH09-202663A

PTL 2: WO2015/122379

PTL 3: JP2020-164365A

SUMMARY OF INVENTION

### Technical Problem

In the boron nitride powder described in PTL 3, both the boron nitride particles having an average particle diameter of 50 μm or more and less than 100 μm and the boron nitride particles having an average particle diameter of 5 μm or more and less than 30 μm are boron nitride particles formed by aggregation of primary particles of boron nitride. Incidentally, when the boron nitride particles formed by aggregation of primary particles of boron nitride have a small average particle diameter, the porosity of the boron nitride particle increases due to the influence of the scale shape of the primary particles of boron nitride. Therefore, when the average particle diameter of the boron nitride particles is less than 30 μm, there is a case where the porosity of the boron nitride particle cannot be sufficiently reduced. When the porosity of the boron nitride particle is large, the thermal conductivity of the boron nitride particle decreases.

Further, in the method for producing spherical boron nitride fine particles described in PTL 2, boron nitride particles having a low porosity can be produced, but it is difficult to produce boron nitride particles having an average particle diameter of 5 μm or more and less than 30 μm.

Therefore, an object of the present invention is to provide a boron nitride particle having a low porosity, which has been difficult to produce, for example, a boron nitride particle having characteristics in which a boron nitride particle having a low porosity can be produced even when the average particle diameter is 5 μm or more and less than 30 μm, and to provide a heat dissipation sheet including the boron nitride particle.

### Solution to Problem

As a result of diligent research, the present inventors have found that the above-mentioned problems can be solved by forming a cross section of a void of a boron nitride particle into a predetermined shape, and have completed the present invention. The present invention is summarized as follows.
[1] A boron nitride particle including a streaky void in cross section.
[2] The boron nitride particle according to the above [1], in which a porosity is 5% or less.
[3] The boron nitride particle according to the above [1] or [2], in which a ratio of a length to a width of the void (length/width) is 3 to 30, and the width is 0.5 μm or less.
[4] The boron nitride particle according to any one of the above [1] to [3], in which the boron nitride particle includes a plurality of voids, and at least one of the voids is a streaky void along a circumferential direction.
[5] The boron nitride particle according to any one of the above [1] to [4], in which a crushing strength is 10 to 40 MPa.
[6] The boron nitride particle according to any one of the above [1] to [5], in which an average circularity is 0.9 or more.
[7] A heat dissipation sheet obtained by forming a thermally conductive resin composition including the boron nitride particle according to any one of the above [1] to [6] and a resin.

### Advantageous Effects of Invention

According to the present invention, it is possible to provide a boron nitride particle having a small porosity and a heat dissipation sheet including the boron nitride particle.

### BRIEF DESCRIPTION OF DRAWINGS

FIG. 1 is a diagram for explaining an example of the method for producing the boron nitride particle(s) of the present invention.

FIG. 2 is a result of Raman analysis of the boron nitride particle(s) 1.

FIG. 3 is a scanning type electron microscope (SEM) photograph of the appearance of the boron nitride particle(s) 1.

FIGS. 4(a) to (c) are scanning type electron microscope (SEM) photographs of cross sections of boron nitride particle(s) 1.

### DESCRIPTION OF EMBODIMENTS

Hereinafter, embodiments of the present invention are described. Note that the present invention is not limited to the following embodiments.

### Boron Nitride Particle

### Shape of Void

The boron nitride particle of the present invention in cross section includes a streaky void. When the void in the cross section of the boron nitride particle is not streaky, the void in the cross section of the boron nitride particle becomes large, and the thermal conductivity of the boron nitride particle becomes small. Note that the void in the cross section of the boron nitride particle formed by aggregation of primary particles of the scale shaped boron nitride does not have a streaky shape.

### Porosity

The porosity (area ratio) of the cross section of the boron nitride particle of the present invention is preferably 5% or less. When the porosity of the cross section of the boron nitride particle is 5% or less, the thermal conductivity of the boron nitride particle can be further increased. In addition, when the porosity of the cross section of the boron nitride particle is 5% or less, the resin does not enter the inside of the boron nitride particle, and thus it is possible to increase the filling amount of the boron nitride particle in the heat dissipation sheet, and whereby it is possible to further increase the thermal conductivity of the heat dissipation sheet. From such a viewpoint, the porosity of the cross section of the boron nitride particle is more preferably 4% or less, and still more preferably 3% or less. In addition, the lower limit of the range of the porosity of the cross section of the boron nitride particle of the present invention is not particularly limited, but is usually 0.1% or more. Further, the lower limit can be 0.5% or more, or 1.0% or more. Note that the porosity of the cross section of the boron nitride particle can be measured using a method described in Examples below. In addition, in the boron nitride particle formed by aggregation of the primary particles of the boron nitride with the scale shape, it is difficult to densely aggregate (gather) the primary particles of the boron nitride. Therefore, it is difficult to set the porosity of the cross section of the boron nitride particle formed by aggregation of the primary particles of the boron nitride with the scale shape to 5% or less.

### Ratio of Length to Width of Void (Length/Width)

In the cross section of the boron nitride particle of the present invention, the ratio of the length to the width of the void (length/width) is preferably 3 to 30. When the ratio of the length to the width of the void (length/width) is 3 or more, the porosity of the cross section of the boron nitride particle can be decreased, and therefore, the thermal conductivity of the boron nitride particle can be increased. The lower limit can be 5 or more, or 10 or more. In addition, when the ratio of the length to the width of the void (length/width) is 30 or less, the strength of the boron nitride particle can be increased, and thus it is possible to prevent the boron nitride particle from being destroyed when the resin and the boron nitride particle are mixed. From such a viewpoint, the ratio of the length to the width of the void (length/width) is more preferably 5 to 25, further preferably 6 to 20, and still further preferably 10 to 20.

### Width of Void

In the cross section of the boron nitride particle of the present invention, the width of the void is preferably 0.5 μm or less. When the width of the void is 0.5 μm or less, the porosity of the cross section of the boron nitride particle can be reduced, and thus the thermal conductivity of the boron nitride particle can be increased. From such a viewpoint, the width of the void is more preferably 0.4 μm or less, and still more preferably 0.3 μm or less. In the cross section of the boron nitride particle of the present invention, the lower limit of the range of the width of the void is not particularly limited, but is usually 0.01 μm or more, can be 0.05 μm or more, and can be 0.1 μm or more. Note that the width of the void in the cross section of the boron nitride particle can be measured using a method described in Examples below. In addition, since the void in the cross section of the boron nitride particle formed by aggregation of the primary particles of the boron nitride with the scale shape is not streaky, the average value of the widths of the voids in the cross section of the boron nitride particle formed by aggregation of the primary particles of the boron nitride with the scale shape is larger than 0.5 μm.

### Direction in Which Streaky Void Extends

The boron nitride particle of the present invention in the cross section preferably has a plurality of voids, and at least one of the voids among the voids is preferably a streaky void along the circumferential direction. When the direction in which the streaky void extends is the circumferential direction, a decrease in the strength of the boron nitride particle due to the void can be suppressed. Note that the streaky void refers to a void having a ratio of the length to the width of the void of 3 or more. It is more preferable that half or more of the voids among the plurality of voids in the cross section of the boron nitride particle of the present invention are streaky voids along the circumferential direction, it is further preferable that two thirds or more of the voids among the plurality of voids in the cross section of the boron nitride particle of the present invention are streaky voids along the circumferential direction, and it is still further preferable that all of the voids among the plurality of voids in the cross section of the boron nitride particle of the present invention are streaky voids along the circumferential direction. Note that the direction in which the streaky void extends in the cross section of the boron nitride particle can be measured using a method described in Examples below.

### Average Particle Diameter

The average particle diameter of the boron nitride particles of the present invention is not particularly limited, but is preferably 30 μm or less, more preferably 25 μm or less, and further preferably 21 μm or less. Further, on the other hand, the average particle diameter of the boron nitride particles of the present invention is preferably 1 μm or more, more preferably 2 μm or more, and still more preferably 3 μm or more. Note that the average particle diameter of the boron nitride particles can be measured using a method described in Examples below.

### Crushing Strength

The crushing strength of the boron nitride particle of the present invention is preferably 10 MPa or more. When the crushing strength of the boron nitride particle is 10 MPa or more, for example, the boron nitride particle can be prevented from being destroyed during mixing of the resin and the boron nitride particle in order to produce the heat dissipation sheet. From such a viewpoint, the crushing strength of the boron nitride particle of the present invention is more preferably 13 MPa or more, further preferably 15 MPa or more, and still further preferably 20MPa or more. The upper limit of the range of the crushing strength of the boron nitride particle of the present invention is not particularly limited, but is usually 40 MPa or less, can be 35 MPa or less, and can be 30 MPa or less. Note that the crushing strength of the boron nitride particle can be measured using a method described in Examples below.

### Average Circularity

The average circularity of the boron nitride particles of the present invention is preferably 0.9 or more. When the average circularity of the boron nitride particles is 0.9 or more, the fluidity of the boron nitride particle is improved. As a result, for example, when the resin and the boron nitride particle are mixed to produce the heat dissipation sheet, the boron nitride particle can be easily filled in the resin, and generation of a void in the heat dissipation sheet can be suppressed. From such a viewpoint, the average circularity of the boron nitride particles of the present invention is more preferably 0.91 or more, further preferably 0.92 or more, and still further preferably 0.95 or more. The upper limit of the range of the average circularity of the boron nitride particles of the present invention is not particularly limited, but is usually 0.99 or less, can be 0.97 or less, and can be 0.96 or less. Note that the average circularity of the boron nitride particles can be measured using a method described in Examples below.

### Method for Producing Boron Nitride Particle

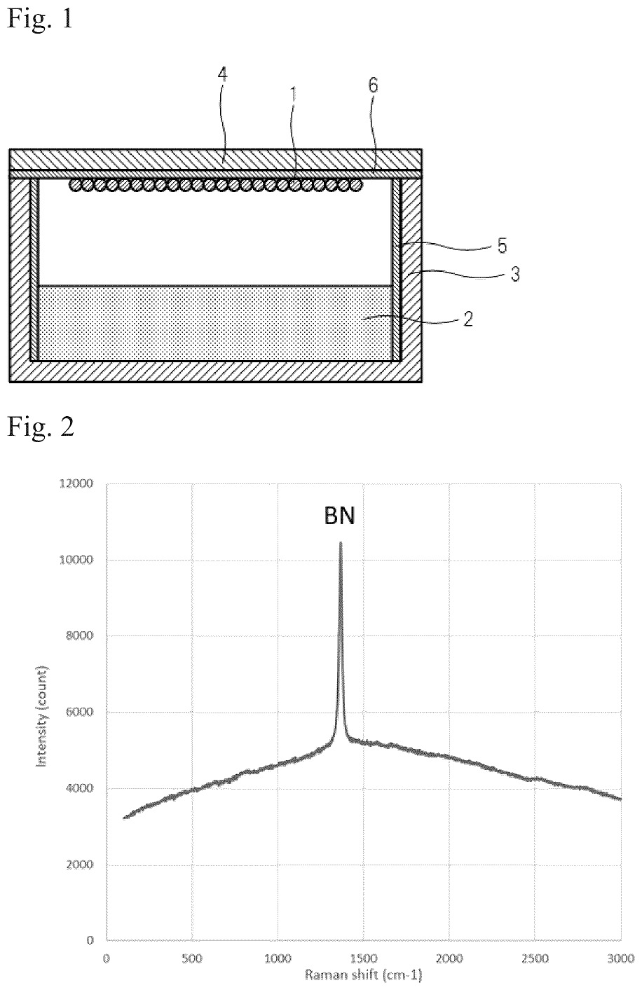

The boron nitride particle of the present invention can be produced, for example, by the following production method. An example of the method for producing the boron nitride particle of the present invention is described with reference to FIG. 1. The boron nitride particle can be produced, for example, by a method for producing boron nitride particle including a step of placing a mixture 2 containing boron carbide and boron acid in a container 3 formed of a carbon material in which an opening part is closed by a lid 4 formed of a carbon material, and placing a base material 6 formed of a carbon material under the lid 4 (placing step); and a step of producing the boron nitride particle on the base material 6 under the lid 3 by heating and pressurizing the inside of the container 3 in a nitrogen atmosphere (producing step).

The container 3 formed of a carbon material is a container capable of containing the mixture 2. Note that a base material 5 formed of a carbon material can be further placed inside the container 3. The container 3 can be, for example, a carbon crucible. The lid 4 formed of a carbon material covers the opening part of the container 3 and increases the vapor pressure of the boron compound produced by heating the mixture 2 in the container 3. In the placing step, for example, the mixture 2 can be placed on the bottom part of the container 3, the base material 5 can be placed on the side wall surface of the container 3, and the base material 6 can be placed under the lid 4. The base materials 5 and 6 formed of a carbon material can have, for example, a sheet shape, a plate shape, or a rod shape. The base materials 5 and 6 formed of a carbon material can be, for example, a carbon sheet (graphite sheet), a carbon plate, or a carbon rod.

The boron carbide in the mixture 2 can, for example, be in powder form (boron carbide powder). The boric acid in the mixture 2 can, for example, be in powder form (boric acid powder). The mixture 2 is obtained by, for example, mixing a boron carbide powder and a boric acid powder by a known method.

The boron carbide powder can be produced by a known production method. Examples of the method for producing the boron carbide powder include a method in which boric acid and acetylene black are mixed, and then the mixture is heated in an inert gas (for example, nitrogen gas) atmosphere at 1800 to 2400° C. for 1 to 10 hours to obtain agglomerated boron carbide particle. The agglomerated boron carbide particle obtained by this method can be appropriately subjected to pulverization, sieving, rinsing, impurity-removing, drying, and the like to obtain the boron carbide powder.

The average particle diameter of the boron carbide powder can be adjusted by adjusting the pulverization time of the agglomerated carbon boron particle. The average particle diameter of the boron carbide powder can be 5 μm or more, 7 μm or more, or 10 μm or more, and can be 100 μm or less, 90 μm or less, 80 μm or less, or 70 μm or less. The average particle diameter of the boron carbide powder can be measured using a laser diffraction-scattering method.

The mixing ratio of boron carbide and boric acid can be appropriately selected. The content of the boric acid in the mixture is preferably 2 parts by mass or more, more preferably 5 parts by mass or more, and even more preferably 8 parts by mass or more, and can be 100 parts by mass or less, 90 parts by mass or less, or 80 parts by mass or less, with respect to 100 parts by mass of the boron carbide, from the viewpoint that the boron nitride particle is likely to become large.

The mixture containing boron carbide and boric acid can further contain other components. Examples of the other components include silicon carbide, carbon, and iron oxide. When the mixture containing boron carbide and boric acid further contains silicon carbide, boron nitride particle having no open end can be easily obtained.

The inside of the container 3 is in a nitrogen atmosphere containing, for example, 95% by volume or more of nitrogen gas. The content of the nitrogen gas in the nitrogen atmosphere is preferably 95% by volume or more, more preferably 99.9% by volume or more, and can be substantially 100% by volume. The nitrogen atmosphere can contain an ammonia gas or the like in addition to the nitrogen gas.

The heating temperature is preferably 1300° C. or higher, more preferably 1350° C. or higher, and still more preferably 1400° C. or higher, from the viewpoint that the boron nitride particle is likely to become large. The heating temperature can be 2100° C. or less, 2000° C. or less, or 1900° C. or less.

The pressure at the time of pressurizing is preferably 0.05 MPa or more, more preferably 0.3 MPa or more, and still more preferably 0.6 MPa or more, from the viewpoint that the boron nitride particle is likely to become large. The pressure at the time of pressurizing can be 1.0 MPa or less, or 0.9 MPa or less.

The time for which heating and pressurizing are performed is preferably 5 minutes or more, and more preferably 10 minutes or more, from the viewpoint that the boron nitride particle is likely to become large. The time for heating and pressurizing can be 10 hours or less, or 5 hours or less.

According to this manufacturing method, the above-described boron nitride particle(s) 1 are generated on the base material 6 placed under the lid 4. Therefore, the boron nitride particle(s) 1 are obtained by collecting the boron nitride particle(s) 1 on the base material 6. The fact that the particle(s) 1 formed on the base material 6 are boron nitride particles can be confirmed by collecting a part of the particles from the base material, performing Raman analysis on the collected particles, and detecting a peak derived from boron nitride.

Note that although the following description does not limit the present invention, it is considered that the boron nitride particle is formed on the base material 6 by the above method for the following reasons. When the mixture 2 in the container 3 is heated, the vapor pressure of the boron compound generated by heating the mixture 2 increases in the container 3. As a result, the surface of the base material 6 placed under the lid 4 serves as a nucleus, and a droplet of the boron compound is formed on the surface of the base material 6. Thereafter, the vapor of the boron compound in the container 3 is condensed on the surface of the droplet of the boron compound, and the droplet of the boron compound on the base material 6 grows. The grown droplet is then nitrided. It is considered that boron nitride particle is formed on the base material 6 placed under the lid 4 by repeating the growth and nitridation of the droplet in this manner. Note that the size of the droplet of the boron compound formed on the surface of the base material 6 placed under the lid 4 can be controlled by adjusting the amount of boric acid. Further, by this, it is possible to obtain a boron nitride powder having a desired average particle diameter with a small porosity, for example, boron nitride particle having an average particle diameter of 5 μm or more and less than 30 μm and a small porosity.

### Heat Dissipation Sheet

The heat dissipation sheet of the present invention is obtained by forming a thermally conductive resin composition containing the boron nitride particle of the present invention and a resin.

Examples of the resin used for the heat dissipation sheet of the present invention include epoxy resin, silicone resin, silicone rubber, acrylic resin, phenol resin, melamine resin, urea resin, unsaturated polyester, fluororesin, polyimide, polyamideimide, polyetherimide, polybutylene terephthalate, polyethylene terephthalate, polyphenylene ether, polyphenylene sulfide, wholly aromatic polyester, polysulfone, liquid crystal polymer, polyether sulfone, polycarbonate, maleimide-modified resin, ABS (acrylonitrile-butadiene-styrene) resin, AAS (acrylonitrile-acrylic rubber-styrene) resin, and AES (acrylonitrile-ethylene-propylene-diene rubber-styrene) resin.

### Content of Boron Nitride Particle

The content of the boron nitride particle can be 15% by volume or more, 20% by volume or more, 30% by volume or more, 40% by volume or more, 50% by volume or more, or 60% by volume or more, based on the total volume of the thermally conductive resin composition, from the viewpoint of improving the thermal conductivity of the heat dissipation material and easily obtaining excellent heat dissipation property. The content of the boron nitride particle can be 85% by volume or less, 80% by volume or less, 70% by volume or less, 60% by volume or less, 50% by volume or less, or 40% by volume or less, based on the total volume of the thermally conductive resin composition, from the viewpoint that generation of the void can be suppressed when the thermally conductive resin composition is formed into a sheet-shaped heat dissipation material, and a decrease in insulation properties and mechanical strength of the sheet-shaped heat dissipation material can be suppressed.

### Content of Resin

The content of the resin can be appropriately adjusted according to the use, required characteristics, and the like of the resin composition. The content of the resin can be, for example, 15% by volume or more, 20% by volume or more, 30% by volume or more, 40% by volume or more, 50% by volume or more, or 60% by volume or more, and can be 85% by volume or less, 70% by volume or less, 60% by volume or less, 50% by volume or less, or 40% by volume or less, based on the total volume of the thermally conductive resin composition.

### Curing Agent

The thermally conductive resin composition can further contain a curing agent for curing the resin. The curing agent is appropriately selected depending on the type of the resin. Examples of the curing agent used together with the epoxy resin include a phenol novolac compound, acid anhydride, an amino compound, and an imidazole compound, and an imidazole compound is suitably used. The content of the curing agent can be, for example, 0.5 parts by mass or more, or 1 part by mass or more, and can be 15 parts by mass or less, or 10 parts by mass or less, with respect to 100 parts by mass of the resin.

### Other Components

The thermally conductive resin composition can further contain other components. Other components can be a curing accelerator (curing catalyst), a coupling agent, a wet dispersant, a surface adjusting agent, and the like.

Examples of the curing accelerator (curing catalyst) include a phosphorus-based curing accelerator such as tetraphenylphosphonium tetraphenylborate and triphenyl phosphate, an imidazole-based curing accelerator such as 2-phenyl-4,5-dihydroxymethylimidazole, and an amine-based curing accelerator such as boron trifluoride monoethylamine.

Examples of the coupling agent include a silane-based coupling agent, a titanate-based coupling agent, and an aluminate-based coupling agent. Examples of the chemical bonding group contained in these coupling agents include a vinyl group, an epoxy group, an amino group, a methacryl group, and a mercapto group.

Examples of the wet dispersant include a phosphoric acid ester salt, carboxylic acid ester, polyester, an acrylic copolymer, and a block copolymer.

Examples of the surface adjusting agent include an acryl-based surface adjusting agent, a silicone-based surface adjusting agent, a vinyl-based surface adjusting agent, and a fluorine-based surface adjusting agent.

### Method for Producing Heat Dissipation Sheet

The heat dissipation sheet of the present invention can be produced, for example, by a production method including a step (A) of blending the boron nitride particle of the present invention and a resin to prepare a thermally conductive resin composition, a step (B) of forming the thermally conductive resin composition into a sheet shape to prepare a thermally conductive resin composition sheet, and a step (C) of heating and pressurizing the thermally conductive resin composition sheet under vacuum.

### (Step (A))

In the step (A), the boron nitride particle of the present invention and a resin are blended to prepare a thermally conductive resin composition. The boron nitride particle and the resin used in the step (A) have already been described, and thus the description thereof is omitted.

### (Step (B))

In the step (B), the thermally conductive resin composition is formed into a sheet shape to prepare a thermally conductive resin composition sheet. For example, the thermally conductive resin composition can be formed into a sheet shape by a doctor blade method or calendering. However, when the thermally conductive resin composition passes through the calender rolls, there is a possibility that the boron nitride particle in the thermally conductive resin composition is destroyed. Therefore, it is preferable to form the thermally conductive resin composition into a sheet shape by the doctor blade method.

### (Step (C))

In the step (C), the thermally conductive resin composition sheet is heated and pressurized under vacuum. By this, the filling property of the boron nitride particle in the heat dissipation sheet can be further enhanced, and the heat conductivity of the heat dissipation sheet can be made more excellent. From the viewpoint of improving the filling property of the boron nitride particle, the pressure in the vacuum environment at the time of heating and pressurizing the thermally conductive resin composition sheet is preferably 0.1 to 5 kPa, and more preferably 0.1 to 3 kPa. Further, the heating temperature of the thermally conductive resin composition sheet is preferably 120 to 200° C., and more preferably 130 to 180° C. In addition, the pressure at the time of pressurizing the thermally conductive resin composition sheet is preferably 80 to 250 kg/cm², and more preferably 100 to 200 kg/cm².

### EXAMPLES

Hereinafter, the present invention is described in detail with reference to Examples. Note that the present invention is not limited to the following Examples.

### Evaluation of Boron Nitride Particle

### Shape of Void and Direction in Which Streaky Void Extends

The carbon sheet on which the boron nitride particle was generated was embedded in a sample embedding resin for an electron microscope (manufactured by BUEHLER, product name “Epocure 2”), and the sample embedding resin for the electron microscope was cured. Then, the cured resin was cut with a diamond cutter so that the cross section of the boron nitride particle appeared, and then the cut surface was polished by a CP (cross section polisher) method. The cured resin having the polished cut surface was fixed to a sample stage, and then the cut surface of the cured resin was subjected to osmium coating. Then, the cross section of the boron nitride particle was observed using a scanning type electron microscope (for example, “JSM-6010LA” (manufactured by JEOL Ltd.)), and the shape of the void and the direction in which the streaky void extends were examined.

### Porosity

A cured resin was prepared in the same manner as in the evaluation of the shape of the void and the direction in which the streaky void extends, and the cut surface cut with a diamond cutter was subjected to osmium coating. Then, the cross section of the boron nitride particle was photographed in 10 visual fields at a magnification of 3000 times using a scanning type electron microscope (for example, “JSM-6010LA” (manufactured by JEOL Ltd.)). Using image analysis software (product name: Mac-View, manufactured by Mountech Co., Ltd.), the photographed image was binarized so that a void could be extracted in the photographed image of the cross section of the boron nitride particle, the area ratio of the porosity in the cross section of the boron nitride particle was measured for the images of 10 visual fields, and the average value thereof was defined as the porosity in the cross section of the boron nitride particle.

### Width of Void and Ratio of Length to Width of Void (Length/Width)

A cured resin was prepared in the same manner as in the evaluation of the shape of the void and the direction in which the streaky void extends, and the cut surface cut with a diamond cutter was polished. The cured resin having the polished cut surface was fixed to a sample stage, and then the cut surface of the cured resin was subjected to osmium coating. Then, the cross section of the boron nitride particle was photographed in 10 visual fields at a magnification of 3000 times using a scanning type electron microscope (for example, “JSM-6010LA” (manufactured by JEOL Ltd.)). Using image analysis software (product name: Mac-View, manufactured by Mountech Co., Ltd.), the photographed image was binarized so that a void could be extracted in the photographed image of the cross section of the boron nitride particle. Then, the length of the voids and the maximum values of the width of the voids were measured for 100 voids, and the average value of the length of the voids and the average value of the maximum values of the width of the voids were defined as the width and the length of the void in the cross section of the boron nitride particle. Then, the ratio of the length to the width of the void (length/width) was calculated.

### Average Particle Diameter 50 particles collected from the base material were subjected to SEM observation (×500), and the average particle diameter was calculated from the 50 images.

### Crushing Strength

The crushing strength of the boron nitride particle was measured in accordance with JIS R1639-5:2007. Specifically, after the boron nitride particle was dispersed on a sample stage of a micro compression tester (“MCT-W500” manufactured by Shimadzu Corporation), five boron nitride particles were selected and compression test was performed one by one. Further, the crushing strength (σ: MPa) was calculated from a dimensionless number (α=2.48) that varies depending on the position in the particles, the crushing test force (P:N), and the particle diameter (d:μm) using the formula σ=α×P/(π×d²). The crushing strength of 20 inorganic filler components were subjected to Weibull plotting in accordance with JIS R1625: 2010, and the crushing strength at which the cumulative destruction rate was 63.2% was defined as the crushing strength of the boron nitride particle.

### Average Circularity

For an image (magnification: 500 times, image resolution: 1280×1024 pixels) of the boron nitride particle photographed using a scanning type electron microscope (SEM), the projected area(S) and the peripheral length (L) of the boron nitride particle were calculated by image analysis using image analysis software (for example, product name: MacView, manufactured by Mountech Co., Ltd.). Next, using the projected area (S) and the peripheral length (L), the circularity was determined according to the following formula:

$$Circularity = 4 π S / {L}^{2}$$

The average value of the circularities obtained for 50 randomly selected boron nitride particles was calculated as the average circularity.

### Production of Boron Nitride Particle

### (Boron Nitride Particle 1)

The agglomerated boron carbide particle was pulverized by a pulverizer to obtain a boron carbide powder having an average particle diameter of 10 μm. 100 parts by mass of the obtained boron carbide powder and 72 parts by mass of boric acid were mixed and filled into a carbon crucible, the opening part of the carbon crucible was covered with a carbon sheet (manufactured by NeoGraf Solutions, LLC), and the carbon sheet was sandwiched between the lid of the carbon crucible and the carbon crucible to fix the carbon sheet. The carbon crucible covered with the lid was heated in a resistance-heating furnace under a nitrogen atmosphere under the conditions of 1600° C. and 0.85 MPa for 10 minutes to form particles on the carbon sheet.

The carbon sheet on which the particles were formed was rinsed with hot water of 80° C. Then, the hot water used for rinsing was subjected to suction filtration to collect the particles formed on the carbon sheet. The collected particles were subjected to Raman analysis using a Raman spectrometer (manufactured by Horiba, Ltd., product name “XploRA PLUS”). The result of this Raman analysis is shown in FIG. 2. As can be seen from FIG. 2, only a peak derived from boron nitride was detected, and it was confirmed that the boron nitride particle was produced.

### (Boron Nitride Particle 2)

Boron nitride particle 2 was produced in the same manner as the boron nitride particle 1 except that the content of boric acid was changed from 72 parts by mass to 36 parts by mass. Further, it could be confirmed by Raman analysis that the boron nitride particle was produced.

### (Boron Nitride Particle 3)

Boron nitride particle 3 was produced in the same manner as the boron nitride particle 1 except that the content of boric acid was changed from 72 parts by mass to 9 parts by mass. Further, it could be confirmed by Raman analysis that the boron nitride particle was produced.

### (Boron Nitride Particle 4)

Boron nitride particle 4 was produced in the same manner as the boron nitride particle 1 except that the content of boric acid was changed from 72 parts by mass to 100 parts by mass. Further, it could be confirmed by Raman analysis that the boron nitride particle was produced.

### (Boron Nitride Particle 5)

### Synthesis of Born Carbide

Boron carbide (B₄C) was synthesized by mixing 100 parts by mass of orthoboric acid (hereinafter referred to as boric acid) manufactured by Nippon Denko Co., Ltd. and 35 parts by mass of acetylene black (HS100) manufactured by Denka Company Limited using a Henschel mixer, and then filling it into a graphite crucible, and heating at 2200° C. for 5 hours in an argon atmosphere in an arc furnace. The synthesized boron carbide agglomerate was pulverized with a ball mill for 3 hours, sieved to a particle diameter of 75 μm or less using a sieve screen, and further rinsed with a nitric acid aqueous solution to remove impurities such as iron, and then filtered and dried to prepare a boron carbide powder having an average particle diameter of 10 μm.

### Pressurization and Nitridation Step

The synthesized boron carbide was filled into a boron nitride crucible, and then heated for 10 hours under the conditions of 2000° C. and 9 atmospheric pressure (0.8 MPa) in a nitrogen atmosphere using a resistance-heating furnace to obtain boron carbonitride (B₄CN₄).

### Decarbonation and Crystallization Step

After 100 parts by mass of the synthesized boron carbonitride and 100 parts by mass of boric acid were mixed using a Henschel mixer, filled into a boron nitride crucible, and heated under the pressure condition of 0.1 MPa in a nitrogen atmosphere using a resistance-heating furnace with an increase in temperature at a rate of temperature increase of 10° C./min from a room temperature to 1200° C. and a rate of temperature increase of 5° C./min from 1200° C., at a firing temperature of 2000° C. for a retention time of 5 hours to synthesize aggregated boron nitride particle in which the primary particles aggregate to form an agglomerate. The synthesized aggregated boron nitride particle was crushed for 15 minutes by a Henschel mixer, and then classified with a nylon sieve having a sieve opening of 150 μm using a sieve screen. The fired product was crushed and classified to obtain the boron nitride particle 5. As a result of SEM observation, the obtained boron nitride particle 5 was the aggregated particle formed by aggregation of the primary particles.

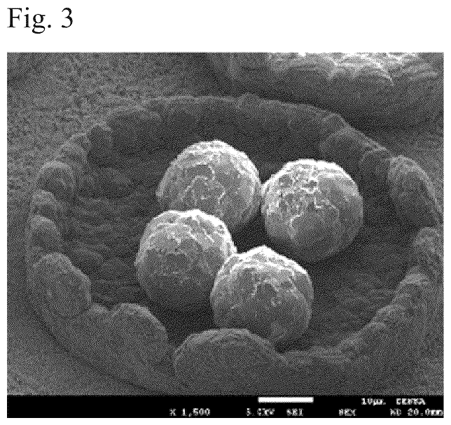

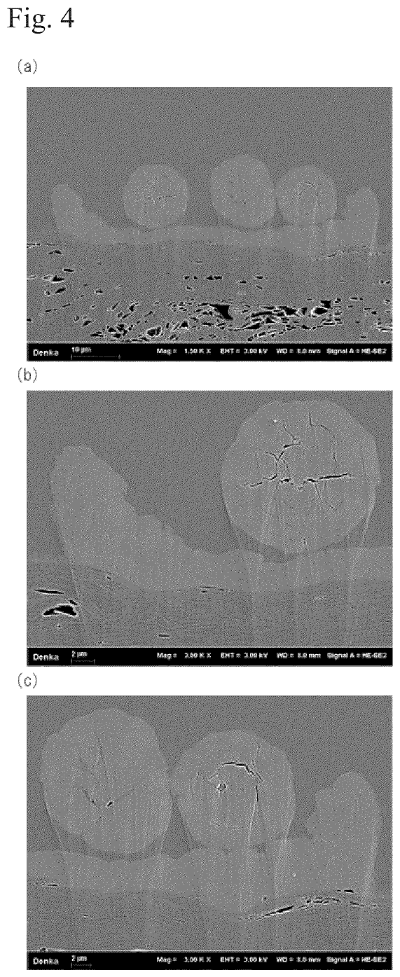

The evaluation results are shown in Table 1. As an example, a scanning type electron microscope (SEM) photograph of the appearance of the boron nitride particle 1 is shown in FIG. 3, and SEM photographs of the cross section of the boron nitride particle 1 are shown in FIGS. 4(a) to (c), respectively. From the SEM photographs of FIGS. 4(a) to (c), it was found that the voids in the cross section of the boron nitride particle 1 had a streaky shape. Further, it was found that a plurality of voids were present in the cross section of the boron nitride particle 1, and at least one of the voids among the voids was a streaky void along the circumferential direction.

TABLE 1

| | | | | | Ratio of | Presence or | | | |
|---|---|---|---|---|---|---|---|---|---|
| | | | | | Length to | Absence of | | | |
| | | | | | Width of | Streaky Void | Average | | |
| | | | | Width | Void | along | Particle | Crushing | |
| | | Shape of | Porosity | of Void | (Length/ | Circumferential | Diameter | Strength | Average |
| | | Void | [%] | [μm] | Width) | Direction | [μm] | [MPa] | Circularity |
| Boron | Example | Streaky | 2 | 0.26 | 11 | Present | 14 | 26 | 0.93 |
| Nitride | | | | | | | | | |
| Particle 1 | | | | | | | | | |
| Boron | Example | Streaky | 3 | 0.15 | 15 | Present | 10 | 22 | 0.95 |
| Nitride | | | | | | | | | |
| Particle 2 | | | | | | | | | |
| Boron | Example | Streaky | 2 | 0.1 | 13 | Present | 8 | 24 | 0.94 |
| Nitride | | | | | | | | | |
| Particle 3 | | | | | | | | | |
| Boron | Example | Streaky | 2 | 0.3 | 20 | Present | 21 | 20 | 0.91 |
| Nitride | | | | | | | | | |
| Particle 4 | | | | | | | | | |
| Boron | Com- | Polygonal | 66 | — | — | Absent | 26 | 8.9 | 0.82 |
| Nitride | parative | | | | | | | | |
| Particle 5 | Example | | | | | | | | |

In the boron nitride particles 1 to 4 of Examples, the voids in the cross section each had a streaky shape, and hence the porosity in the cross section could be reduced. On the other hand, in the boron nitride particle 5 of Comparative Example 1, since the shape of the void in the cross section was not streaky, the porosity in the cross section was increased.

### REFERENCE SIGNS LIST

1 boron nitride particle(s)
2 mixture
3 container
4 lid
5, 6 base material

1. A boron nitride particle comprising a streaky void in cross section.

2. The boron nitride particle according to claim 1, wherein a porosity is 5% or less.

3. The boron nitride particle according to claim 1,
wherein a ratio of a length to a width of the void (length/width) is 3 to 30, and the width is 0.5 μm or less.

4. The boron nitride particle according to claim 1, wherein the boron nitride particle comprises a plurality of voids, and at least one of the voids is a streaky void along a circumferential direction.

5. The boron nitride particle according to claim 1, wherein a crushing strength is 10 to 40 MPa.

6. The boron nitride particle according to claim 1, wherein an average circularity is 0.9 or more.

7. A heat dissipation sheet obtained by forming a thermally conductive resin composition comprising the boron nitride particle according to claim 1 and a resin.
